(19) United States
(12) Patent Application Publication
(10) Pub. No.: US 2006/0188257 A1
(43) Pub. Date: Aug. 24, 2006

(54) Method for transmitting data in synchronous Ethernet passive optical network

(75) Inventors: Jong-Kwon Kim, Gunpo-si (KR); Chang-Sup Shim, Seoul (KR); Yun-Je Oh, Yongin-si (KR); Jun-Ho Koh, Suwon-si (KR); Jae-Hun Cho, Seoul (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/337,327

(22) Filed: Jan. 23, 2006

(30) Foreign Application Priority Data
Jan. 27, 2005 (KR) 2005-7597

(51) Int. Cl. H04J 14/00

(52) U.S. Cl. 398/49

(57) ABSTRACT

Transmitting data in a synchronous Ethernet passive optical network employs a synchronous Ethernet for ensuring QoS during transmission of multi-media data, thereby specifying transmission of synchronous data and asynchronous data, respectively. The Ethernet passive optical network has an optical line terminal, which is a central base station, and a plurality of optical network units. The method includes the steps of forming a synchronous frame using the OLT to transmit synchronous data for the ONUs, forming an asynchronous frame using the OLT to transmit asynchronous data for the ONUs, forming a super frame including the synchronous and asynchronous frames using the OLT, and transmitting the super frame using the OLT.

### CLAIM OF PRIORITY

This application claims the benefit under 35 U.S.C. 119(a) of an application entitled “Method for Transmitting Data in Synchronous Ethernet Passive Optical Network” filed with the Korean Intellectual Property Office on Jan. 27, 2005 and assigned Serial No. 2005-7597, the contents of which are incorporated herein by reference.

### BACKGROUND OF INVENTION

The present invention relates to a passive optical network. More particularly, the present invention relates a passive optical network using residential synchronous Ethernet.

A conventional passive optical network (PON) employs a time-division scheme or a wave-division scheme.

A PON employing the time-division scheme is known as an Ethernet PON. Due to the characteristics of the PON, the Ethernet PON uses a particular scheme for media access control (MAC) in order to prevent collision between upstream signals.

A typical Ethernet PON has a separate time domain for each subscriber that allows subscribers to transmit upstream signals at respective times so as to avoid collision between the signals of different subscribers. However, since the time domain is established regardless of signal type, competition arises between upstream signals if more than one type of upstream signals exists. In the latter case, a time delay may occur. Since multi-media signals are sensitive to the time delay, the conventional Ethernet PON is unsuitable for transmitting multi-media signals requiring exact time information without time delay.

Recently, a technique for transmitting multi-media data such as video/voice data using the conventional Ethernet has been actively discussed. The Ethernet for transmitting multi-media data is referred to as synchronous Ethernet.

FIG. 1 is a view illustrating the structure of a transmission cycle in a conventional synchronous Ethernet.

As shown in FIG. 1, the conventional synchronous Ethernet transmits data with a transmission cycle of 125 μsec. The transmission cycle includes an Async frame 12 for transmitting asynchronous data and a Sync frame 11 for transmitting synchronous data.

According to the proposal under the discussion (although the proposal is subject to change), the Sync frame 11 for transmitting the synchronous data has the highest priority in the transmission cycle and includes 738-byte sub-Sync frames 11-1, 11-2, . . . , 11-M. The Async frame 12 for transmitting the asynchronous data includes sub-Async frames having a variable length in a corresponding area. Each of the sub-Sync frames 11-1, 11-2, . . . , 11-M includes n Sync packets 101-1 to 101-n.

However, in order to apply the above synchronous Ethernet to the Ethernet PON, it is necessary to perform the MAC in a manner discretely different from that of the conventional Ethernet PON, which competitively grants access onto a communication medium using the CSMA/CD (carrier sense multiple access/collision detect) protocol defined in IEEE 802.3.

More specifically, it is necessary to provide an Ethernet PON using a synchronous Ethernet capable of transmitting multi-media signals, which require exact time information, separately from general signals in such manner that the Ethernet PON can support various multi-media without degrading QoS (quality of service).

### SUMMARY OF THE INVENTION

The present invention addresses the above-mentioned problems occurring in the prior art.

In one aspect, the present invention transmits data in a synchronous Ethernet passive optical network (PON), which employs a synchronous Ethernet for ensuring QoS during transmission of multi-media data, thereby specifying transmission of synchronous data and asynchronous data, respectively.

The present invention accordingly provides a method for transmitting data in an Ethernet passive optical network (PON) including an optical line terminal (OLT), which is a central base station, and a plurality of optical network units (ONUs), the method comprising the steps of: forming a synchronous frame using the OLT to transmit synchronous data that is for the ONUs; forming an asynchronous frame using the OLT to transmit asynchronous data that is for the ONUs; using the OLT to form a super frame so as to include the synchronous and asynchronous frames; and transmitting the formed super frame using the OLT.

According to another aspect of the present invention, there is provided a method for transmitting data in an Ethernet passive optical network (PON) including an optical line terminal (OLT), which is a central base station, and a plurality of optical network units (ONUs), the method comprising the steps of: using each ONU in forming a respective sub-synchronous frame to transmit synchronous data that is for the OLT; using each ONU in forming a respective asynchronous frame to transmit asynchronous data that is for the OLT; scheduling and transmitting the sub-synchronous frames using the ONUs such that the sub-synchronous frames are combined as one synchronous frame in a splitter connecting the OLT with the ONUs; and scheduling and transmitting the asynchronous frames using the ONUs such that the asynchronous frames are combined as one asynchronous frame in the splitter connecting the OLT with the ONUs.

According to still another aspect of the present invention, there is provided a method for transmitting data in an Ethernet passive optical network (PON) including an optical line terminal (OLT), which is a central base station, and a plurality of optical network units (ONUs), the method comprising the steps of: using each ONU in forming respective time slots to transmit synchronous data that is for the OLT; using each ONU in forming respective asynchronous frames to transmit asynchronous data that is for the ONUs; using the ONUs in scheduling said respective time slots, and transmitting in correspondence with said respective time slots, such that resulting transmissions are combined as one sub-synchronous frame in a splitter connecting the OLT with the ONUs; and using the ONUs in scheduling and transmitting said respective asynchronous frames such that the transmitted asynchronous frames are combined as one asynchronous frame in the splitter connecting the OLT with the ONUs.

### BRIEF DESCRIPTION OF THE DRAWINGS

The above and other objects, features and advantages of the present invention will be more apparent from the following detailed description taken in conjunction with the accompanying drawings, in which:

FIG. 1 is a view illustrating the structure of a transmission cycle in a conventional synchronous Ethernet;

FIG. 2 is a view illustrating a layer structure of a synchronous Ethernet according to the present invention;

FIG. 3 is a detailed view illustrating a synchronous frame process unit, which is a part of a data link layer for processing a synchronous frame in a conventional Ethernet layer structure;

FIG. 4 is a view illustrating a downstream transmission scheme in a conventional Ethernet PON;

FIG. 5 is a view illustrating a downstream transmission scheme in a synchronous Ethernet PON according to a first embodiment of the present invention;

FIG. 6 is a view illustrating a downstream transmission scheme in a synchronous Ethernet PON according to a second embodiment of the present invention;

FIG. 7 is a view illustrating an upstream transmission scheme in a conventional Ethernet PON;

FIG. 8 is a view illustrating an upstream transmission scheme in a synchronous Ethernet PON according to a first embodiment of the present invention; and

FIG. 9 is a view illustrating an upstream transmission scheme in a synchronous Ethernet PON according to a second embodiment of the present invention.

### DETAILED DESCRIPTION

Hereinafter, preferred embodiments of the present invention will be described in detail with reference to the accompanied drawings. Note that the same or similar components in drawings are designated by the same reference numerals as far as possible although they are shown in different drawings. In the following description of the present invention, detailed description of known functions and configurations incorporated herein is omitted for clarity of presentation.

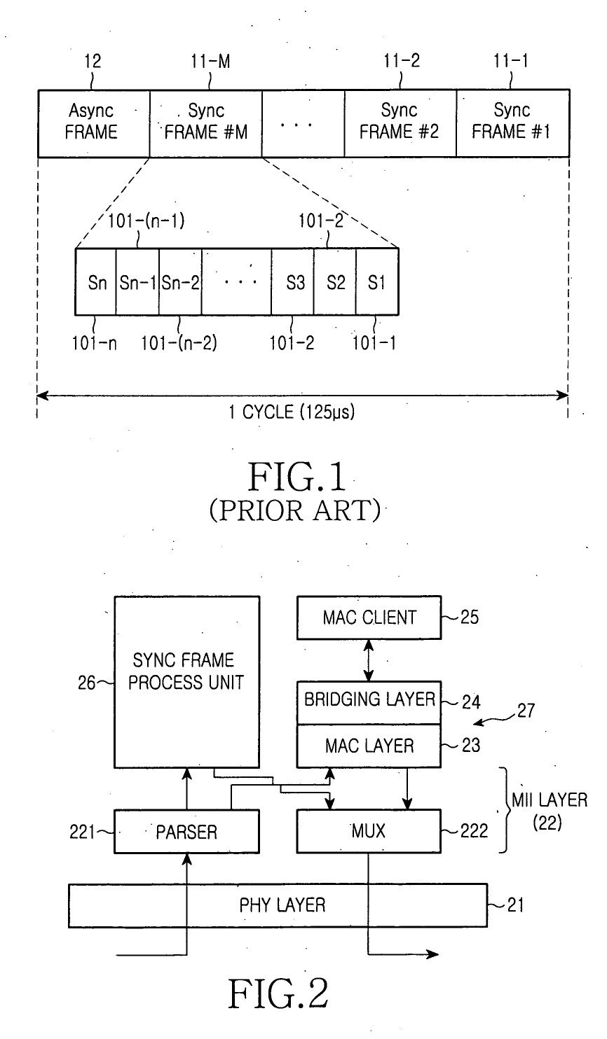

FIG. 1 is a view illustrating the structure of a transmission cycle in a conventional synchronous Ethernet.

As shown in FIG. 1, the conventional synchronous Ethernet transmits data with a transmission cycle of 125 μsec. The transmission cycle includes an Async frame 12 for transmitting asynchronous data and a Sync frame 11 for transmitting synchronous data.

According to the proposal under the discussion (although the proposal is subject to change), the Sync frame 11 for transmitting the synchronous data has the highest priority in the transmission cycle and includes 738-byte sub-Sync frames 11-1, 11-2, . . . , 11-M. The Async frame 12 for transmitting the asynchronous data includes sub-Async frames having a variable length in a corresponding area. Each of the sub-Sync frames 11-1, 11-2, . . . , 11-M includes n Sync packets 101-1 to 101 -n. Each of the Sync packets 101-1 to 101-n can be represented as one time slot.

FIG. 2 is a view illustrating a layer structure of a conventional synchronous Ethernet. The layer structure includes a PHY layer 21, which is a lowermost layer of an OSI layer structure and directly relates to hardware so as to allow input/output of an Ethernet frame. An xMII (x media independent interface) layer 22 is an 802.3 MAC-PLS (physical layer signaling) interface layer for connecting the PHY layer 21 with a data link layer. A Sync frame process unit 26 is designed for processing Sync frames, and an Async frame process unit 27 is designed for processing Async frames. Similar to the conventional layer structure, the Async frame process unit 27 includes a MAC layer 23, which converts a packet from an upper layer (MAC client) 25 into an Ethernet frame so as to transmit the Ethernet frame into the PHY layer 21. The unit 27 also converts an Ethernet frame from the PHY layer 21 into a packet so as to transmit the packet into the upper layer 25. Additionally included in the unit 27 is a bridging layer 24, which analyzes the received Ethernet frame and determines the relay of the Ethernet frame to the destination based on information contained in the Ethernet frame.

The xMII layer 22, according to the present invention, includes a parser 221, which divides the synchronous Ethernet frame into sub-Sync frames and sub-Async frames so as to transmit them to upper layers 23, 25 according to the contents thereof. The layer 22 further includes a MUX 222 for multiplexing, in one cycle, the sub-Sync frames and sub-Async frames from the Sync frame process unit 26 and the Async frame process unit 27, respectively.

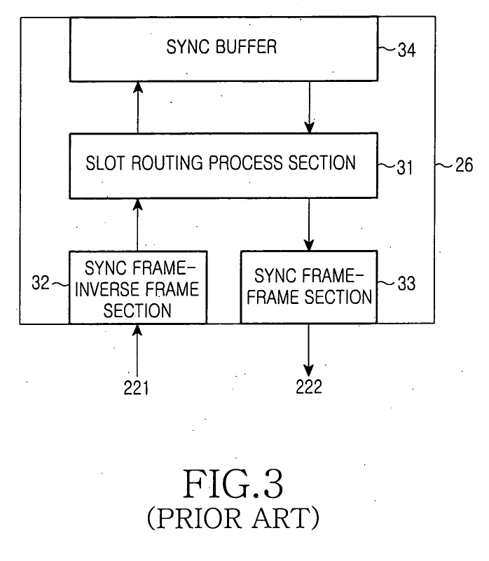

FIG. 3 is a detailed view illustrating the Sync frame process unit 26, which is a part of a data link layer for processing the Sync frame in the conventional Ethernet layer structure. The Sync frame process unit 26 includes a Sync buffer 34 connected to an upper layer, which processes multi-media information, so as to perform a buffering operation for ensuring continuous data input/output. The unit 26 further includes a Sync frame-frame section 33 for creating a Sync header with respect to Sync data transmitted from the upper layer through the Sync buffer 34 A Sync frame-inverse frame section 32 erases the Sync header in a sub-Sync frame transmitted from a lower layer (e.g., parser) and transmits the sub-Sync frame to the Sync buffer 34. A slot routing process section 31 connected to the Sync frame-frame section 33, the Sync frame-inverse frame section 32, and lower layers 221 and 222 provides a transmission route for the sub-Sync frame. The Sync frame-frame section 33, the Sync frame-inverse frame section 32, and the slot routing process section 31 can be implemented in software.

In the case of a downstream signal (i.e., a signal from an upper layer of an OLT to a lower layer), the multi-media data (i.e., Sync packet), such as broadcast data having an interface (ASI or the like), are received through a corresponding interface and stored in the Sync buffer 34 of the Sync frame process unit 26. A Sync header is created, in the form of software, for the data stored in the Sync buffer 34 by means of the Sync frame-frame section 33 and the slot routing process section 31. Slots are allocated to a payload, thereby forming the sub-Sync frame. The Sync header includes information related to a frame counter for counting the sub-Sync frames and a cycle counter for counting transmission cycles, as well as slot routing information for slot allocation and slot reservation information.

The sub-Sync frame formed in the Sync frame process unit 26 is transmitted to the MUX 222 of the xMII layer 22. A number of the sub-Sync frames, together with the sub-Async frames transmitted to the MUX 222 through the Async frame process unit 27, are combined into a synchronous Ethernet frame allocated to one cycle. Then, the synchronous Ethernet frame is transmitted to other equipment through the PHY layer 21. The Async frame process unit 27 consists of the bridging layer 24 and the MAC layer 23 and operates as a typical IEEE 802.3 data link layer.

In the case of an upstream signal, the synchronous Ethernet frame received through the PHY layer 21 is divided into a Sync frame part and an Async frame part by means of a parser 221 of the xMII layer 22. The Sync frame part is transferred to the Sync frame process unit 26 and the Async frame part is transferred to the Async frame process unit 27. As mentioned above, the Async frame process unit 27 consists of the bridging layer 24 and the MAC layer 23 and operates as a typical IEEE 802.3 data link layer.

The sub-Sync frame of the Sync frame part transferred to the Sync frame process unit 26 is transmitted, in the form of software, to the Sync frame-inverse frame section 32 and through the slot routing process section 31. Then, after extracting multi-media data from the sub-Sync frame based on information related to the slot of the payload contained in the Sync header, the multi-media data are transmitted, through the Sync buffer 34, to an upper layer for processing the multi-media data while ensuring QoS.

Signal transmission in the synchronous Ethernet PON, whose layer structure is discussed immediately above, may be performed as downstream transmission and as upstream transmission.

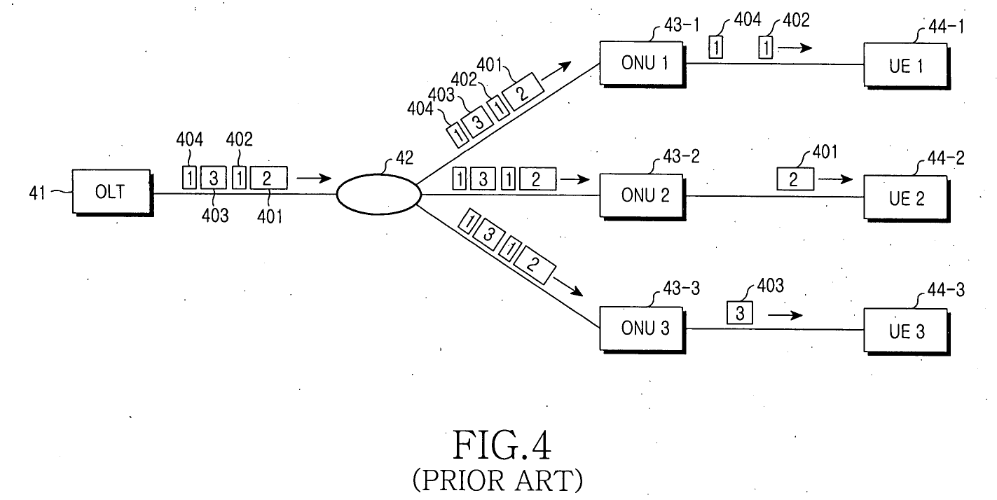

FIG. 4 is a view illustrating a downstream transmission scheme in the conventional Ethernet PON. When an OLT (optical line terminal) 41 transmits data 401, 402, 403, 404 that is destined for, UEs (user equipments) 44-1, 44-2, 44-3, the data are transferred to respective ONUs (optical network units) 43-1, 43-2, 43-3 through a splitter 42. The ONUs 43-1, 43-2, 43-3 extract data for the UEs 44-1, 44-2, 44-3 based on destination address information of the MAC header and transmit the data to the UEs.

The synchronous Ethernet PON according to the present invention performs the downstream transmission differently and in two ways.

One of them is to transmit Sync data by allocating the sub-Sync frames among respective UEs 44-1, 44-2, 44-3, and the other is to transmit Sync data by allocating the time slots of the sub-Sync frame to respective UEs.

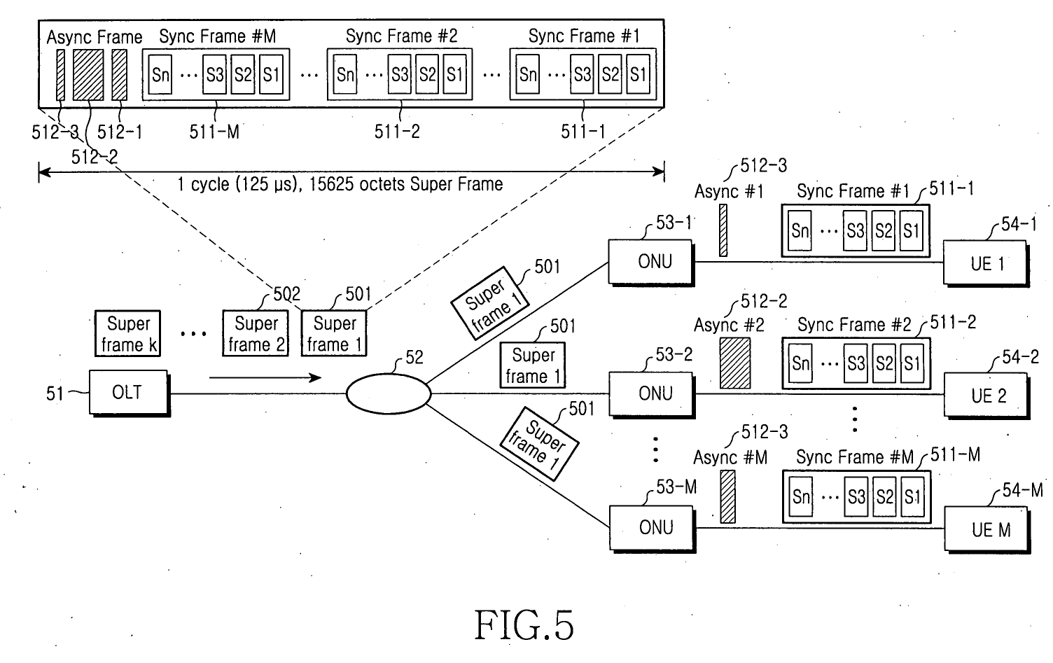

FIG. 5 is a view illustrating downstream transmission in the synchronous Ethernet PON according to a first embodiment of the present invention. The Sync data are transmitted to UEs 44-1, 44-2, 44-3 by allocating the sub-Sync frames among respective UEs. In this case, transmission of the Async data is identical to that of the conventional Ethernet PON shown in FIG. 4.

The Sync frames and Async frames to be transmitted to UEs 54-1 to 54-M from an OLT 51 are prepared in the form of super frames 501, 502, 503. The super frames 501, 502, 503 are each transferred to each of the ONUs 53-1 to 53-M through a splitter 52. Portions of the super frame 501 are selectively transmitted by each of the ONUs 53-1 to 53-M to the UEs 54-1 to 54-M. In effect, the ONUs 53-1 to 53-M distinguish the Sync frames from the Async frames, and select the respective sub-Sync frame for transmission to the UE 54-1 to 54-M.

In summary, the super frames 501, 502, 503 each include sub-Sync frames 511-1, 511-2., 511-M, which are allocated to the UEs 54-1 to 54-M. The Async frames 512-1, 512-2, 512-3 are, likewise, respectively allocated.

Referring to the downstream transmission in the synchronous Ethernet PON according to the first embodiment of the present invention shown in FIG. 5, the ONUs 53-1 to 53-M distinguish the Sync signals according to sub-Sync frame unit, but it is not necessary for the ONUs 53-1 to 53-M to distinguish signals in the sub-Sync frame by slot unit.

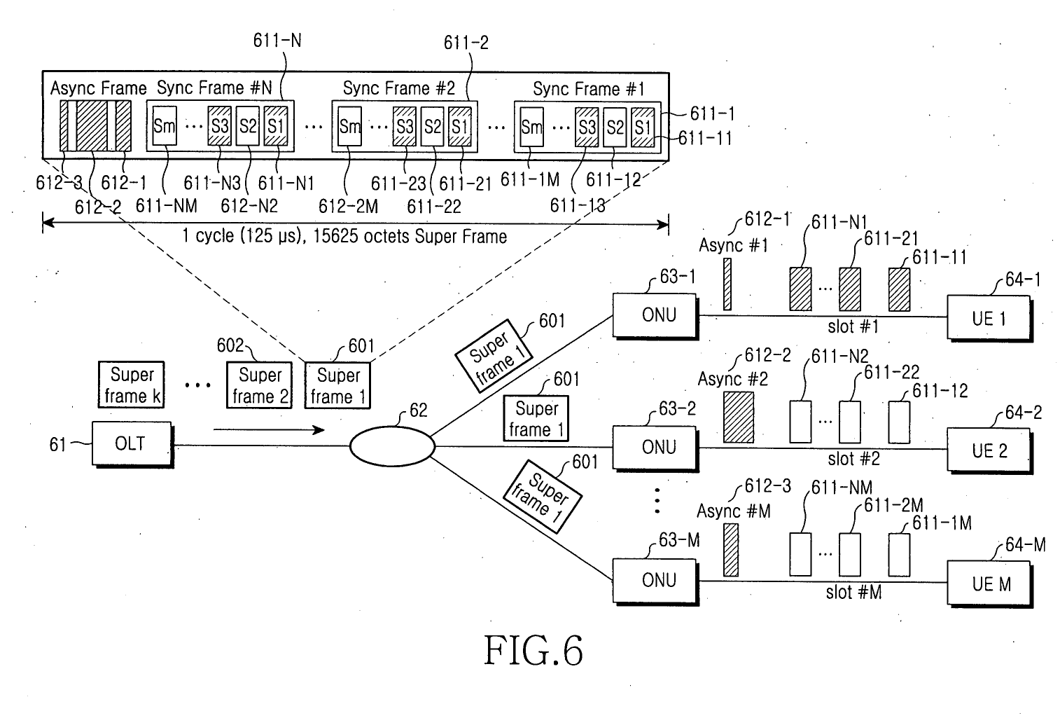

FIG. 6 is a view illustrating a downstream transmission scheme in a synchronous Ethernet PON according to a second embodiment of the present invention.

According to the second embodiment of the present invention, the Sync data are transmitted to UEs 64-1, 64-2, . . . 64-M by allocating the time slots of the sub-Sync frame to respective UEs. In this case, transmission of the Async data is identical to that of the conventional Ethernet PON shown in FIG. 4.

The Sync frames and Async frames to be transmitted to UEs 64-1 to 64-M from an OLT 61 are prepared in the form of super frames 601, 602, 603. The super frames 601, 602, 603 are each transferred to each of the ONUs 63-1 to 63-M through a splitter 62. Then, the ONUs 63-1 to 63-M selectively transmit respective portions of the super frame 601 to the UEs 64-1 to 64-M. This involves distinguishing the Sync frames from the Async frames, and selecting time slots for respective UEs 64-1 to 64-M.

The super frames 601, 602, 603 each include a plurality of sub-Sync frames 611-1, 611-2., 611-N for transmission of the Sync data. The sub-Sync frames 611-1, 611-2, 611-N respectively include Sync time slots 611-11 to 611-IM, 611-21 to 611-2M, . . . , and 611-N1 to 611-NM. Async frames 612-1, 612-2, 612-3 are also included in each of the super frames 601, 602, 603. Content of each super frame 601, 602, 603 is allocated among the UEs 64-1 to 64-M.

Referring to the downstream transmission in the synchronous Ethernet PON according to the second embodiment of the present invention shown in FIG. 6, the ONUs 63-1 to 63-M distinguish the Sync signals for the UEs 64-1 to 64-M in view of a time slot unit in the sub-Sync frame. Therefore, it is necessary for the ONUs 63-1 to 63-M to distinguish signals in the sub-Sync frame in view of a slot unit.

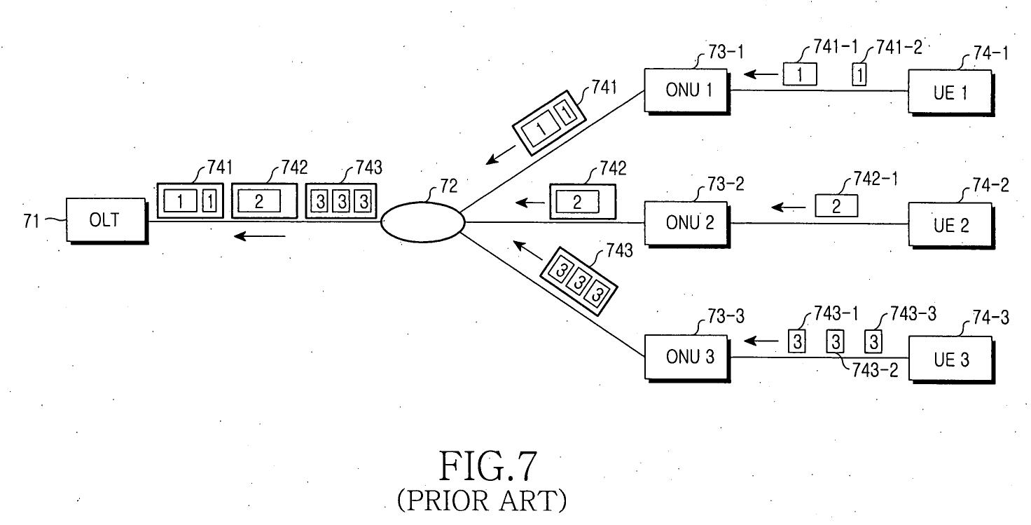

Meanwhile, upstream transmission in the conventional Ethernet PON is shown in FIG. 7.

FIG. 7 is a view illustrating an upstream transmission scheme in the conventional Ethernet PON. Data 741-1, 741-2, 742-1, 743-1, 743-2, 743-3 from UEs 74-1, 74-2, 74-3 are transmitted to ONUs 73-1, 73-2, 73-3. The latter combine the data to form packets 741, 742, 743. In addition, the ONUs 73-1, 73-2 and 73-3 schedule the packets 741, 742, 743 and sequentially transmit the packets to an OLT 71.

Different from the upstream transmission in the conventional Ethernet PON shown in FIG. 7, the synchronous Ethernet PON according to the present invention performs the upstream transmission in two ways.

One of them is to allow UEs to transmit Sync data by allocating one respective sub-Sync frame per one cycle to each UE, and the other is to allow UEs to transmit Sync data including time slots for UEs by allocating the time slots of the sub-Sync frame among the UEs.

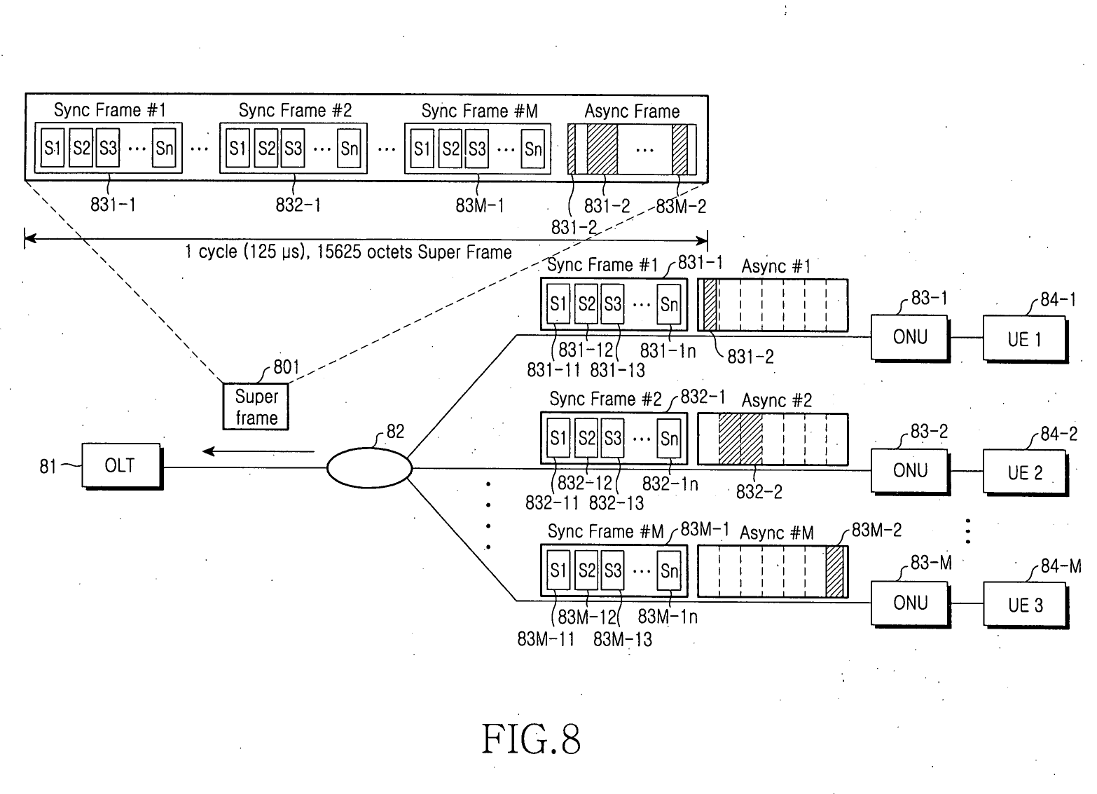

FIG. 8 is a view illustrating an upstream transmission scheme in a synchronous Ethernet PON according to a first embodiment of the present invention.

According to the first embodiment of the present invention, one sub-Sync frame per one cycle is allocated to each UE so as to allow the UE to transmit the Sync data.

Sync Ethernet data to be transmitted to ONUs 83-1 to 83-M from UEs 84-1 to 84-M are prepared by a splitter 82 to form a super frame 801, and the super frame is transmitted to the OLT 81.

The super frame 801 formed through the splitter 82 has 15625 octets per one cycle. The super frame 801 includes sub-Sync frames 831-1, 832-1, . . . , 83M-1 and Async frames 831-2, 832-2, . . . , 83M-2 transmitted from the UEs 84-1 to 84-M.

The sub-Sync frames 831-1, 832-1, . . . , 83M-1 created in ONUs 83-1 to 83-M and transmitted to the splitter 82 are scheduled in such a way that they can be allocated to a single super frame 801.

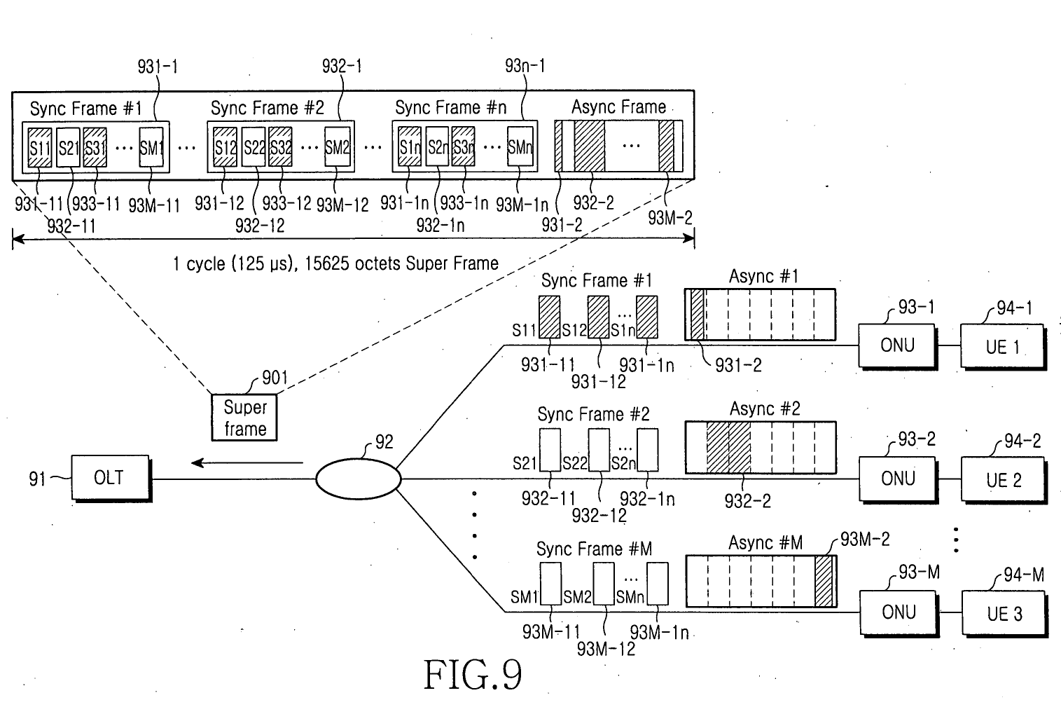

FIG. 9 is a view illustrating an upstream transmission scheme in a synchronous Ethernet PON according to a second embodiment of the present invention. Time slots of the sub-Sync frame are allocated among the UEs so as to allow the UE to transmit the Sync data by means of its respective time slots. Sync Ethernet data transmitted to ONUs 93-1 to 93-M from UEs 94-1 to 94-M are prepared through a splitter 92 to form a super frame 901 and the super frame is transmitted to an OLT 91. The super frame 901 formed through the splitter 92 has 15625 octets per one cycle and includes sub-Sync frames 931-1, 932-1, . . . 93n-1 and Async frames 931-2, 932-2, . . . , 93M-2. The sub-Sync frames 931-1, 932-1, . . . , 93n-1 allow the upstream Sync data to be transmitted with the time slots allocated to the UEs 94-1 to 94-M.

Hereinafter, the upstream transmission for the Sync data according to the second embodiment of the present invention is described in relation to the UE 194-1.

The UE 194-1 transmits Sync data and Async data to the ONU 93-1. Upon receiving the Sync data and Async data from the UE 194-1, the ONU 93-1 creates and transmits the Async frame 931-2 and time slot data 931-11, 931-12, . . . , 931-In for sub-Sync frames.

The splitter 92 sequentially receives time slot data 931-11, 931-12, . . . , 931-1n; 932-11, 932-12, . . . , 932-1n; . . . and 93M-11, 93M-12, . . . , 93M-1n transmitted from the ONUs 93-1 to 93-M for the sub-Sync frames, and thereby forms the sub-Sync frames. In particular and by way of example, one sub-Sync frame may include the time slot data transmitted from the ONUs 93-1 to 93-M for the sub-Sync frames. If the time slot data 931-11 have been input into the splitter 92 from the ONU 193-1, the next time slot data 932-11 is then input into the splitter 92 from the ONU 293-2, and so on in sequence. In this manner, if the time slot data 93M-11 have been input into the splitter 92 from the final ONU 93-M, the sub-Sync frame 1 931-1 is created. After that, sub-Sync frames 2 and 3 are sequentially created. When the final sub-Sync frame has been made, the splitter 92 receives Async data 931-2, 931-2, . . . , and 93M-2 from the ONUs 93-1 to 93-M, thereby forming the Async frame. The Async frame, in combination with the Sync frame 931-1, 932-1, . . . 93n-1, are transmitted as a super frame 901 to the OLT 91.

As described above, the present invention provides a data transmission method in the PON using a synchronous Ethernet, so that the Sync and Async signals can be transmitted through the PON.

In addition, according to the present invention, the Sync signal is transmitted in a frame unit if the Sync signal has a large size. It is also possible to transmit the Sync signal in a slot unit if the Sync signal has a small size or the Sync signal is frequently transmitted. Thus, the present invention offers improved communication efficiency.

The data transmission method according to the present invention can be realized in the form of a program, so that the data transmission method can be stored in a computer-readable record medium, such as CD ROM, RAM, floppy discs, hard discs, or optical magnetic discs.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. A method for transmitting data in an Ethernet passive optical network (PON) including an optical line terminal (OLT), which is a central base station, and a plurality of optical network units (ONUs), the method comprising the acts of:
i) forming a synchronous frame using the OLT to transmit synchronous data that is for the ONUs;
ii) forming an asynchronous frame using the OLT to transmit asynchronous data that is for the ONUs;
iii) using the OLT to form a super frame so as to include the synchronous and asynchronous frames; and
iv) transmitting the formed super frame using the OLT.

2. The method as claimed in claim 1, wherein act i) includes the sub-acts of converting synchronous data to be transmitted, in said transmitting, into sub-synchronous frames and allocating the sub-synchronous frames to respective ones of said ONUs, wherein said forming of the synchronous frame comprises combining said sub-synchronous frames.

3. The method as claimed in claim 2, wherein each ONU receives the transmitted super frame and transmits, from among a plurality of sub-synchronous frames in the received super frame, sub-synchronous frames corresponding to a respective one of said ONUs.

4. The method as claimed in claim 3, wherein the super frame has a transmission cycle of 125 μsec.

5. The method as claimed in claim 2, wherein the super frame has a transmission cycle of 125 μsec.

6. The method as claimed in claim 1, wherein the super frame has a transmission cycle of 125 μsec.

7. The method as claimed in claim 1, wherein act i) includes the sub-acts of allocating time slots among said ONUs and forming sub-synchronous frames by combining data of said time slots, wherein said forming of the synchronous frame comprises combining said sub-synchronous frames.

8. The method as claimed in claim 7, wherein each ONU receives the transmitted super frame and transmits, from among a plurality of time slots in the sub-synchronous frames of the received super frame, from time slots corresponding to a respective one of said ONUs.

9. The method as claimed in claim 7, wherein act i) further includes the sub-acts of converting synchronous data to be transmitted, in said transmitting, into sub-synchronous frames and allocating the sub-synchronous frames to respective ones of said ONUs, wherein said forming of the synchronous frame comprises combining said sub-synchronous frames.

10. The method as claimed in claim 9, further comprising the act of selecting, based upon a size of said synchronous data to be transmitted by act i), between performance of either the further included sub-acts or the allocating and forming sub-acts.

11. The method as claimed in claim 10, wherein the super frame has a transmission cycle of 125 μsec.

12. The method as claimed in claim 9, wherein the super frame has a transmission cycle of 125 μsec.

13. The method as claimed in claim 8, wherein the super frame has a transmission cycle of 125 μsec.

14. The method as claimed in claim 7, wherein the super frame has a transmission cycle of 125 μsec.

15. A method for transmitting data in an Ethernet passive optical network (PON) including an optical line terminal (OLT), which is a central base station, and a plurality of optical network units (ONUs), the method comprising the acts of:
i) using each ONU in forming a respective sub-synchronous frame to transmit synchronous data that is for the OLT;
ii) using each ONU in forming a respective asynchronous frame to transmit asynchronous data that is for the OLT;
iii) scheduling and transmitting the sub-synchronous frames using the ONUs such that the sub-synchronous frames are combined as one synchronous frame in a splitter connecting the OLT with the ONUs; and
iv) scheduling and transmitting the asynchronous frames using the ONUs such that the asynchronous frames. are combined as one asynchronous frame in the splitter connecting the OLT with the ONUs.

16. The method as claimed in claim 15, further comprising the acts of forming a super frame by combining one synchronous frame with one asynchronous frame through the splitter and transmitting the formed super frame into the OLT.

17. The method as claimed in claim 16, wherein the super frame has a transmission cycle of 125 μsec.

18. A method for transmitting data in an Ethernet passive optical network (PON) including an optical line terminal (OLT), which is a central base station, and a plurality of optical network units (ONUs), the method comprising the acts of:
i) using each ONU in forming respective time slots to transmit synchronous data that is for the OLT;
ii) using each ONU in forming respective asynchronous frames to transmit asynchronous data that is for the ONUs;
iii) using the ONUs in scheduling said respective time slots, and transmitting in correspondence with said respective time slots, such that resulting transmissions are combined as one sub-synchronous frame in a splitter connecting the OLT with the ONUs; and
iv) using the ONUs in scheduling and transmitting said respective asynchronous frames such that the transmitted asynchronous frames are combined as one asynchronous frame in the splitter connecting the OLT with the ONUs.

19. The method as claimed in claim 18, further comprising the acts of:
forming a super frame by combining, through the splitter, predetermined ones of sub-synchronous frames formed in act iii) with one asynchronous frame formed in act iv); and
transmitting the super frame into the OLT.

20. The method as claimed in claim 19, wherein the super frame has a transmission cycle of 125 μsec.
